(19) United States
(12) Patent Application Publication
(10) Pub. No.: US 2022/0174446 A1
(43) Pub. Date: Jun. 2, 2022

(54) ACOUSTIC SIGNAL PROCESSING DEVICE, ACOUSTIC SIGNAL PROCESSING SYSTEM, ACOUSTIC SIGNAL PROCESSING METHOD, AND PROGRAM

(71) Applicant: Sony Group Corporation, Tokyo (JP)

(72) Inventor: Ryutaro WATANABE, Tokyo (JP)

(73) Assignee: Sony Group Corporation, Tokyo (JP)

(21) Appl. No.: 17/439,744

(22) PCT Filed: Jan. 24, 2020
(86) PCT No.: PCT/JP2020/002538

§ 371 Date: Sep. 15, 2021

(30) Foreign Application Priority Data
Mar. 22, 2019 (JP) 2019-054090

(51) Int. Cl. H04S 7/00; H04R 3/12

(52) U.S. Cl. CPC H04S 7/302; H04R 3/12; H04S 2400/11; H04R 2499/13; H04S 2420/01

(57) ABSTRACT

There is achieved a configuration that executes sound localization processing applying a head-related transfer function (HRTF) corresponding to a user identified by a user identification, and makes an output from an output unit for each user position. The configuration includes a user identification unit that executes user identification and a user position identification process and a sound localization processing unit that executes sound localization processing using, as a processing parameter, a head-related transfer function (HRTF) specific to the user. The sound localization processing unit executes sound localization processing that treats the HRTF specific to the identified user as a processing parameter, and outputs a signal obtained by the sound localization processing to an output unit for the identified user position. In a case where the user identification unit identifies multiple users, the sound localization processing unit executes the sound localization processing using the HRTF of each of the multiple users in parallel, and outputs processed signals to an output unit for each user position.

### TECHNICAL FIELD

The present disclosure relates to an acoustic signal processing device, an acoustic signal processing system, an acoustic signal processing method, and a program. More specifically, the present disclosure relates to an acoustic signal processing device, an acoustic signal processing system, an acoustic signal processing method, and a program that perform signal processing to set an optimal virtual sound source position for each user (listener).

### BACKGROUND ART

For example, there are systems in which speakers are embedded in the headrest part, at its left and right positions, of a seat where a user such as the driver of a vehicle sits, and sound is output from the speakers.

However, in a case of providing speakers in the headrest part, the user (listener) such as the driver hears sounds coming from behind the ears, which may feel unnatural, and some users may, in some cases, experience listening fatigue.

Sound localization processing is a technology that addresses such a problem. Sound localization processing is audio signal processing that causes a user to perceive sound as if the sound is coming from a virtual sound source position that is different from the actual speaker position, such as a virtual sound source position set to a position in front of the listener, for example.

For example, if an audio signal that has been subjected to sound localization processing is output from a speaker behind the ears of the user (listener), the user will perceive sound as if the sound source is in front of the user.

An example of a disclosed technology of the related art regarding sound localization processing is Patent Document 1 (Japanese Patent Application Laid-Open No. 2003-111200).

Note that the above patent document discloses a configuration that generates sound to output from a speaker by performing signal processing that considers a head-related transfer function (HRTF) from the speaker to the ears of the listener.

Performing signal processing based on the head-related transfer function (HRTF) makes it possible to control the optimal virtual sound source position for the listener.

### CITATION LIST

### Patent Document

Patent Document 1: Japanese Patent Application Laid-Open No. 2003-111200

### SUMMARY OF THE INVENTION

### Problems to be Solved by the Invention

As described above, by outputting a processed signal based on the head-related transfer function (HRTF) from a speaker, it is possible to perform a sound image position control that sets an optimal virtual sound source position for the listener.

However, the head-related transfer function (HRTF) is different for each individual. Consequently, in a case of outputting a processed signal to which a head-related transfer function (HRTF) corresponding to a specific user has been applied from a speaker, there is a problem in that the virtual sound source position is an optimal position for that specific user, but not necessarily an optimal virtual sound source position for another user.

The present disclosure addresses such a problem, and provides an acoustic signal processing device, an acoustic signal processing system, an acoustic signal processing method, and a program capable of controlling the output, from a speaker, of a processed signal to which a head-related transfer function (HRTF) specific to a user (listener) has been applied, and setting an ideal virtual sound source position for each user (listener).

### Solutions to Problems

According to a first aspect of the present disclosure,

there is provided an acoustic signal processing device including:

a user identification unit that executes a user identification process;

an acquisition unit that acquires a head-related transfer function (HRTF) unique to a user identified by the user identification unit, from among one or a plurality of head-related transfer functions (HRTFs); and

a sound localization processing unit that executes sound localization processing using, as a processing parameter, the head-related transfer function (HRTF) unique to the user acquired by the acquisition unit.

Further, according to a second aspect of the present disclosure,

there is provide an acoustic signal processing device including:

a storage unit storing a head-related transfer function (HRTF) unique to a user;

an acquisition unit that acquires the head-related transfer function (HRTF) unique to the user from the storage unit; and

a sound localization processing unit that executes sound localization processing using, as a processing parameter, the head-related transfer function (HRTF) unique to the user acquired by the acquisition unit.

Further, according to a third aspect of the present disclosure,

there is provide an acoustic signal processing system including a user terminal and a server, in which

the server

transmits an audio signal to the user terminal, and

the user terminal includes

a storage unit storing a head-related transfer function (HRTF) unique to a user,

an acquisition unit that acquires the head-related transfer function (HRTF) unique to the user from the storage unit, and

a sound localization processing unit that executes sound localization processing on the audio signal received from the server using, as a processing parameter, the head-related transfer function (HRTF) unique to the user acquired by the acquisition unit.

Further, according to a fourth aspect of the present disclosure,

there is provide an acoustic signal processing method executed in an acoustic signal processing device, the method including:

executing, by a user identification unit, a user identification process;

acquiring, by an acquisition unit, a head-related transfer function (HRTF) unique to a user identified by the user identification unit, from among one or a plurality of head-related transfer functions (HRTFs); and

executing, by a sound localization processing unit, sound localization processing using, as a processing parameter, the head-related transfer function (HRTF) unique to the user acquired by the acquisition unit.

Further, according to a fifth aspect of the present disclosure,

there is provide an acoustic signal processing method executed in an acoustic signal processing device,

the acoustic signal processing device including a storage unit storing a head-related transfer function (HRTF) unique to a user, the method including:

acquiring, by an acquisition unit, the head-related transfer function (HRTF) unique to the user from the storage unit; and

executing, by a sound localization processing unit, sound localization processing using, as a processing parameter, the head-related transfer function (HRTF) unique to the user acquired by the acquisition unit.

Further, according to a sixth aspect of the present disclosure,

there is provide a program causing an acoustic signal processing device to execute acoustic signal processing including:

causing a user identification unit to execute a user identification process;

causing an acquisition unit to acquire a head-related transfer function (HRTF) unique to a user identified by the user identification unit, from among one or a plurality of head-related transfer functions (HRTFs); and

causing a sound localization processing unit to execute sound localization processing using, as a processing parameter, the head-related transfer function (HRTF) unique to the user acquired by the acquisition unit.

Note that a program according to the present disclosure can be provided by a storage medium or a communication medium for providing the program in a computer readable format to an information processing device or computer system that is capable of executing various program codes, for example. Since such a program is provided in a computer readable format, processing in accordance with the program is executed on the information processing device or the computer system.

Other objects, features, and advantages of the present disclosure will become apparent from the detailed description based on the embodiments of the present disclosure and the attached drawings which are described later. Note that, in the present description, a system refers to a logical set configuration including a plurality of devices, and the devices of the configuration are not necessarily included in the same casing.

### Effects of the Invention

According to the configuration of exemplary aspects of the present disclosure, there is achieved a configuration that executes sound localization processing applying a head-related transfer function (HRTF) corresponding to a user identified by a user identification, and makes an output from an output unit for each user position.

Specifically, for example, a user identification unit that executes user identification and a user position identification process and a sound localization processing unit that executes sound localization processing using, as a processing parameter, a head-related transfer function (HRTF) specific to the user are included. The sound localization processing unit executes sound localization processing that treats the HRTF specific to the identified user as a processing parameter, and outputs a signal obtained by the sound localization processing to an output unit for the identified user position. In a case where the user identification unit identifies multiple users, the sound localization processing unit executes the sound localization processing using the HRTF of each of the multiple users in parallel, and outputs processed signals to an output unit for each user position.

According to the present configuration, there is achieved a configuration that executes sound localization processing applying a head-related transfer function (HRTF) corresponding to a user identified by a user identification, and makes an output from an output unit for each user position.

Note that the effects described in this specification are merely non-limiting examples, and there may be additional effects.

### BRIEF DESCRIPTION OF DRAWINGS

FIG. 1 is a diagram for describing an overview of audio signal processing based on sound localization processing and the head-related transfer function (HRTF).

FIG. 2 is a diagram for describing an example of a process of measuring the head-related transfer function (HRTF) treated as a parameter to apply to the sound localization processing.

FIG. 3 is a diagram illustrating an exemplary configuration of a device that performs sound localization processing using the head-related transfer function (HRTF).

FIG. 4 is a diagram for describing an example of executing signal processing based on the head-related transfer function (HRTF) corresponding to each user.

FIG. 5 is a diagram for describing a configuration and process of Embodiment 1 of the present disclosure.

FIG. 6 is a diagram for describing an exemplary configuration of an acoustic signal processing device according to the present disclosure.

FIG. 7 is a diagram for describing an exemplary configuration in which an HRTF database is placed on an external server.

FIG. 8 is a diagram illustrating a flowchart for describing a sequence of a process executed by the acoustic signal processing device according to the present disclosure.

FIG. 9 is a diagram for describing an embodiment in which output control according to the presence or absence of a user is executed.

FIG. 10 is a diagram illustrating a flowchart for describing a sequence of a process executed by the acoustic signal processing device according to the present disclosure.

FIG. 11 is a diagram for describing an embodiment in which the acoustic signal processing device according to the present disclosure is applied to a seat on an airplane.

FIG. 12 is a diagram for describing an embodiment in which the acoustic signal processing device according to the present disclosure is applied to a seat on an airplane.

FIG. 13 is a diagram illustrating a flowchart for describing a sequence of a process executed by the acoustic signal processing device according to the present disclosure.

FIG. 14 is a diagram for describing an embodiment in which the acoustic signal processing device according to the present disclosure is applied to an attraction at an amusement park.

FIG. 15 is a diagram illustrating a flowchart for describing a sequence of a process executed by the acoustic signal processing device according to the present disclosure.

FIG. 16 is a diagram for describing an embodiment in which the acoustic signal processing device according to the present disclosure is applied to an art museum.

FIG. 17 is a diagram illustrating a flowchart for describing a sequence of a process executed by the acoustic signal processing device according to the present disclosure.

FIG. 18 is a diagram for describing an embodiment in which the head-related transfer function (HRTF) specific to a user is stored in a user terminal.

FIG. 19 is a diagram for describing an embodiment in which the head-related transfer function (HRTF) specific to a user is stored in a user terminal.

FIG. 20 is a diagram for describing an exemplary hardware configuration of the acoustic signal processing device, the user terminal, the server, and the like.

### MODE FOR CARRYING OUT THE INVENTION

Hereinafter, an acoustic signal processing device, an acoustic signal processing system, an acoustic signal processing method, and a program according to the present disclosure will be described in detail with reference to the drawings. Note that the description will be given in the following sections.

1. Overview of audio signal processing based on sound localization processing and head-related transfer function (HRTF)

2. Configuration and process of acoustic signal processing device according to present disclosure

3. Embodiment in which output control according to presence or absence of user is executed

4. Other embodiments

5. Embodiment in which head-related transfer function (HRTF) specific to user is stored in user terminal

6. Exemplary hardware configuration of acoustic signal processing device, user terminal, server, and the like

7. Summary of configuration according to present disclosure

### 1. Overview of Audio Signal Processing Based on Sound Localization Processing and Head-Related Transfer Function (HRTF)

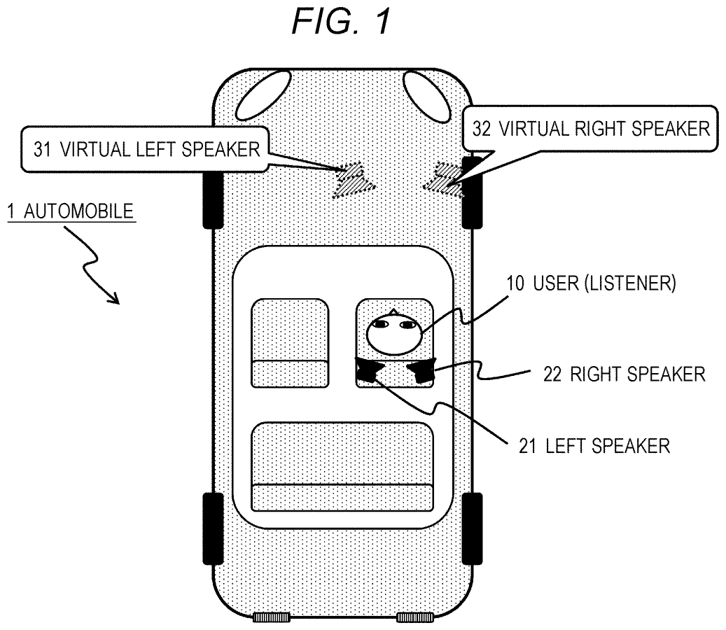

First, with reference to FIG. 1 and subsequent drawings, an overview of audio signal processing based on sound localization processing and the head-related transfer function (HRTF) will be described.

FIG. 1 illustrates an automobile 1. A user (listener) 10 sits in the driver's seat. A left speaker 21 and a right speaker 22 are installed in a headrest part of the driver's seat, and a stereo signal (LR signal) from a sound source such as a CD not illustrated is output from the two speakers.

In the case of providing speakers in the headrest part and simply outputting a stereo signal (LR signal) from the sound source in this way, the user (listener) 10 hears sounds coming from behind the ears, which may feel unnatural, and some users may, in some cases, experience listening fatigue.

To address such a problem, an acoustic signal processing device internal to the automobile 1 executes signal processing on the LR signal output from a sound source such as a CD, and outputs a signal obtained by the signal processing from the left speaker 21 and the right speaker 22. The signal processing is sound localization processing.

As described above, sound localization processing is signal processing causing the user (listener) to perceive sound as if a sound source exists at a virtual sound source position different from the actual speaker position.

In the example illustrated in FIG. 1, it is possible to cause the user to perceive sound as if the L signal of the sound source is being output from a virtual left speaker 31 and the R signal of the sound source is being output from a virtual right speaker 32 at positions (virtual sound source positions) in front of the user (listener) 10.

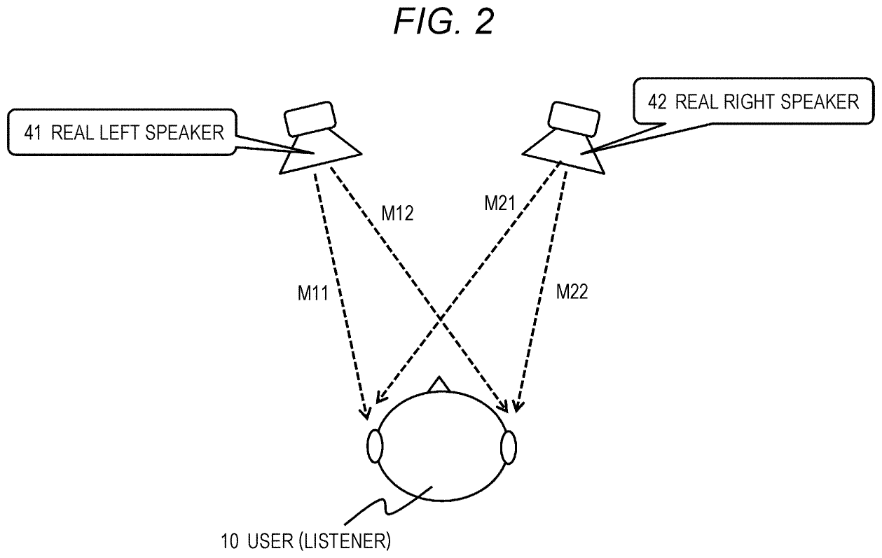

FIG. 2 will be referenced to describe an example of a process of measuring the head-related transfer function (HRTF) treated as a parameter to apply to the sound localization processing. Note that FIG. 2 is a diagram recorded in Patent Document 1 (Japanese Patent Application Laid-Open No. 2003-111200) described earlier as a disclosed technology of the related art regarding sound localization processing. The process according to the present disclosure can be executed by using existing sound localization processing described in Patent Document 1 and the like.

As illustrated in FIG. 2, in a predetermined playback sound field such as a studio for example, a real left speaker 41 and a real right speaker 42 are actually installed at the left and right virtual speaker positions (positions where speakers are expected to exist) with respect to the user 10.

Thereafter, sounds emitted by the real left speaker 41 and the real right speaker 42 are picked up at portions near either ear of the user 10, and a head-related transfer function (HRTF) indicating how the sounds emitted from the real left speaker 41 and the real right speaker 42 change when reaching the portions near either ear of the user 10 is measured.

In the example illustrated in FIG. 2, M11 is the head-related transfer function of the sound from the real left speaker 41 to the left ear of the user 10, and M12 is the head-related transfer function of the sound from the real left speaker 41 to the right ear of the user 10. Similarly, M21 is the head-related transfer function of the sound from the real right speaker 42 to the left ear of the user 10, and M22 is the head-related transfer function of the sound from the real right speaker 42 to the right ear of the user 10.

These head-related transfer functions (HRTFs) are parameters to apply to the signal processing performed on the LR signal output from the sound source such as a CD. The signal obtained by the signal processing using these parameters is output from a left speaker L21 and a right speaker 22 in the headrest part of the driver's seat illustrated in FIG. 1. This arrangement makes it possible to cause the user to perceive sound as if the sounds emitted from the speakers in the headrest part are being output from the virtual speaker positions.

In other words, it is possible to cause the user 10 to perceive sound as if the L signal of the sound source is being output from the virtual left speaker 31 and the R signal of the sound source is being output from the virtual right speaker 32 at positions (virtual sound source positions) in front of the user (listener) 10 illustrated in FIG. 1.

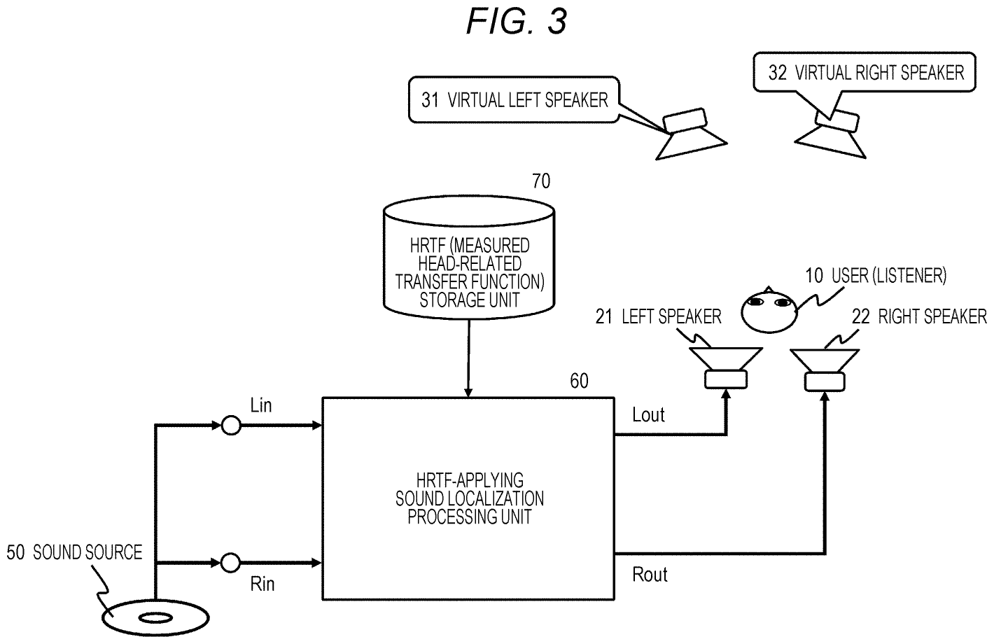

FIG. 3 is a diagram illustrating an exemplary configuration of a device that performs sound localization processing using the head-related transfer function (HRTF).

An L signal and an R signal are reproduced as a stereo signal from a sound source 50 such as a CD. The reproduced signal is inputted (Lin, Rin) into an HRTF-applying sound localization processing unit 60.

The HRTF-applying sound localization processing unit 60 acquires a head-related transfer function (HRTF) measured by the measurement process described earlier with reference to FIG. 2 from an HRTF storage unit 70, executes signal processing applying the acquired data, and generates output signals (Lout, Rout) to be output to the left speaker 21 and the right speaker 22 of the headrest part, for example.

The left speaker 21 outputs the output signal (Lout) processed in the HRTF-applying sound localization processing unit 60.

In addition, the right speaker 22 outputs the output signal (Rout) processed in the HRTF-applying sound localization processing unit 60.

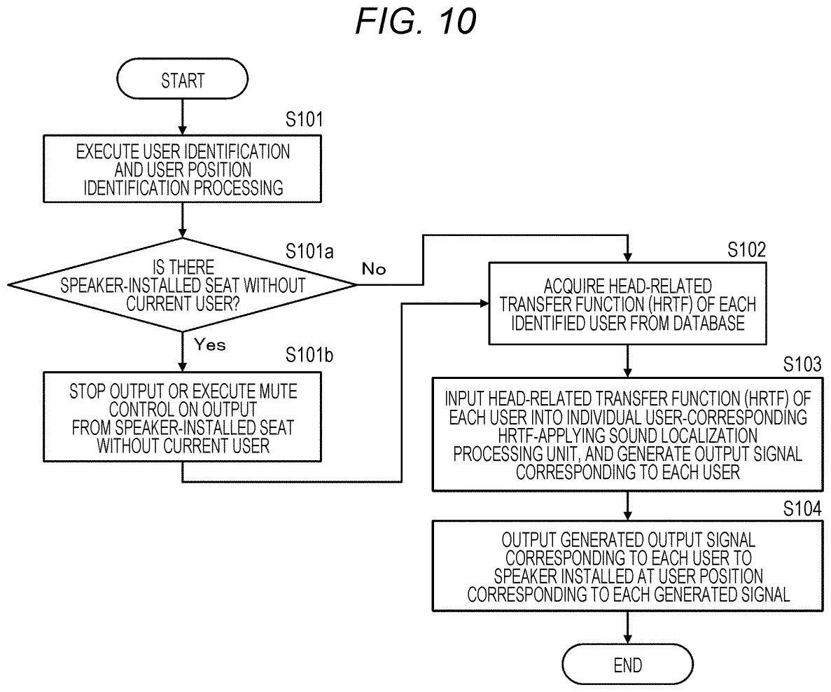

In this way, when a signal subjected to sound localization processing in the HRTF-applying sound localization processing unit 60 is output to the left speaker 21 and the right speaker 22 in the headrest part, the user 10 is able to perceive sound as if the sounds emitted from the speakers in the headrest part are at the virtual speaker positions, or in other words, as if the L signal of the sound source is being output from the virtual left speaker 31 and the R signal of the sound source is being output from the virtual right speaker 32 at positions (virtual sound source positions) in front of the user 3 illustrated in FIG. 10.

Thus, performing signal processing based on the head-related transfer function (HRTF) makes it possible to control the optimal virtual sound position for the listener.

However, as described above, the head-related transfer function (HRTF) is different for each individual. Consequently, in a case of outputting a processed signal to which a head-related transfer function (HRTF) corresponding to a specific user has been applied from a speaker, there is a problem in that the virtual sound source position can be an optimal position for that specific user, but not necessarily an optimal virtual sound source position for another user.

For example, it is anticipated that multiple different users will sit in the driver's seat of the automobile 1 as illustrated in FIG. 1.

In such cases, the HRTF-applying sound localization processing unit 60 illustrated in FIG. 3 needs to perform signal processing based on the head-related transfer function (HRTF) corresponding to each user.

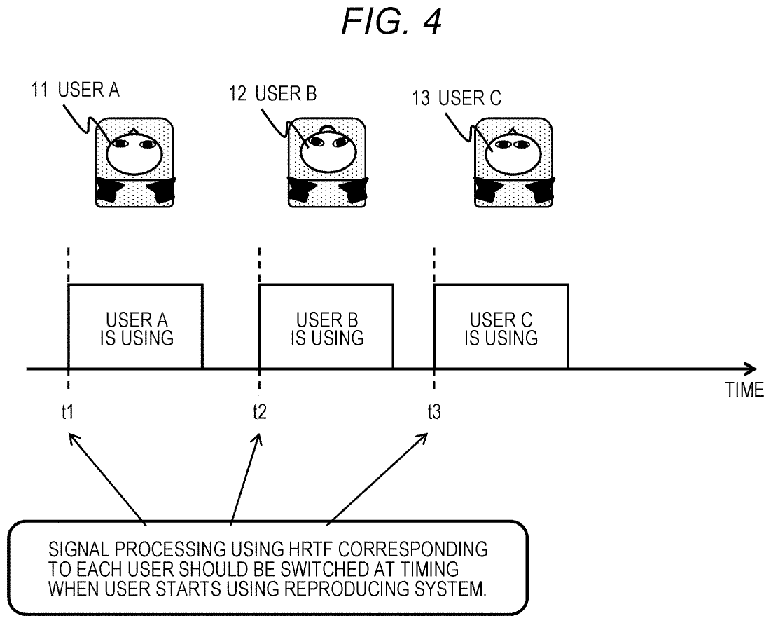

As illustrated in FIG. 4, in the case where three users A to C change places, it is necessary to perform signal processing applying the head-related transfer function (HRTF) corresponding to each user.

In the example of FIG. 4, from a time t1, a user A 11 is sitting in the driver's seat, and in this case, it is necessary to execute signal processing applying the head-related transfer function (HRTF) of the user A 11 to output from the speakers.

From a time t2, a user B 12 is sitting in the driver's seat, and in this case, it is necessary to execute signal processing applying the head-related transfer function (HRTF) of the user B 12 to make an output from the speakers.

Further, from a time t3, a user C 13 is sitting in the driver's seat, and in this case, it would be necessary to execute signal processing applying the head-related transfer function (HRTF) of the user C 13 to make an output from the speakers.

### 2. Configuration and Process of Acoustic Signal Processing Device According to Present Disclosure

Next, a configuration and processing of an acoustic signal processing device according to the present disclosure will be described.

As described above, the head-related transfer function (HRTF) is different for every user, and an optimal virtual sound source position cannot be set unless sound localization processing applying the head-related transfer function (HRTF) unique to the user acting as the listener is executed.

The acoustic signal processing device according to the present disclosure described hereinafter executes a user identification process and a user position identification process, decides the head-related transfer function (HRTF) to apply to the sound localization processing on the basis of identification information, and performs signal processing applying the head-related transfer function (HRTF) corresponding to each user. Moreover, the signal processing result obtained as the output is output from speakers provided at the position of the user having the head-related transfer function (HRTF) applied to the signal processing.

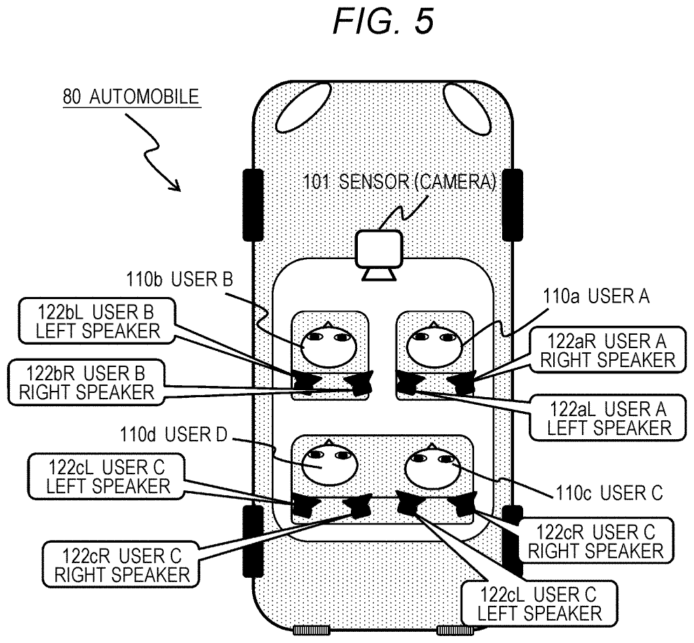

First, a configuration and process of Embodiment 1 according to the present disclosure will be described with reference to FIG. 5 and subsequent drawings.

FIG. 5 illustrates an automobile 80. An acoustic signal processing device 100 according to the present disclosure is installed onboard the automobile 80. Note that a specific example of the configuration of the acoustic signal processing device 100 according to the present disclosure will be described later.

Four users, namely a user A 110a, a user B 110b, a user C 110c, and a user D 110d, are on the automobile 80.

LR speakers corresponding to each user are installed in a headrest part of each user's seat.

In the headrest part for the user A 110a, a user A left speaker 122aL and a user A right speaker 122aR are installed.

In the headrest part for the user B 110b, a user B left speaker 122bL and a user B right speaker 122bR are installed.

In the headrest part for the user C 110c, a user C left speaker 122cL and a user C right speaker 122cR are installed.

In the headrest part for the user D 110d, a user D left speaker 122dL and a user D right speaker 122dR are installed.

Also, a sensor (camera) 101 that captures an image of the face of each of the users A to D is installed onboard the automobile 80.

The captured image of the face of each of the users A to D acquired by the sensor (camera) 101 is inputted into the acoustic signal processing device 100 according to the present disclosure.

The acoustic signal processing device 100 according to the present disclosure executes user identification and user position identification on the basis of the captured image of the face of each of the users A to D acquired by the sensor (camera) 101.

The acoustic signal processing device 100 according to the present disclosure acquires the head-related transfer function (HRTF) of each of the users A to D from a database on the basis of user identification information, and executes signal processing (sound localization processing) applying the acquired head-related transfer function (HRTF) of each of the users A to D in parallel.

Moreover, four pairs of output LR signals obtained by the signal processing (sound localization processing) applying the head-related transfer function (HRTF) of each of the users A to D are output from the LR speakers at the position of each user specified on the basis of user position identification information.

Through these processes, each of the users A to D can individually listen to the output signal obtained by the signal processing (sound localization processing) applying that user's own head-related transfer function (HRTF) from the speakers in the headrest part, and each user can listen to sounds from an ideal virtual sound source position.

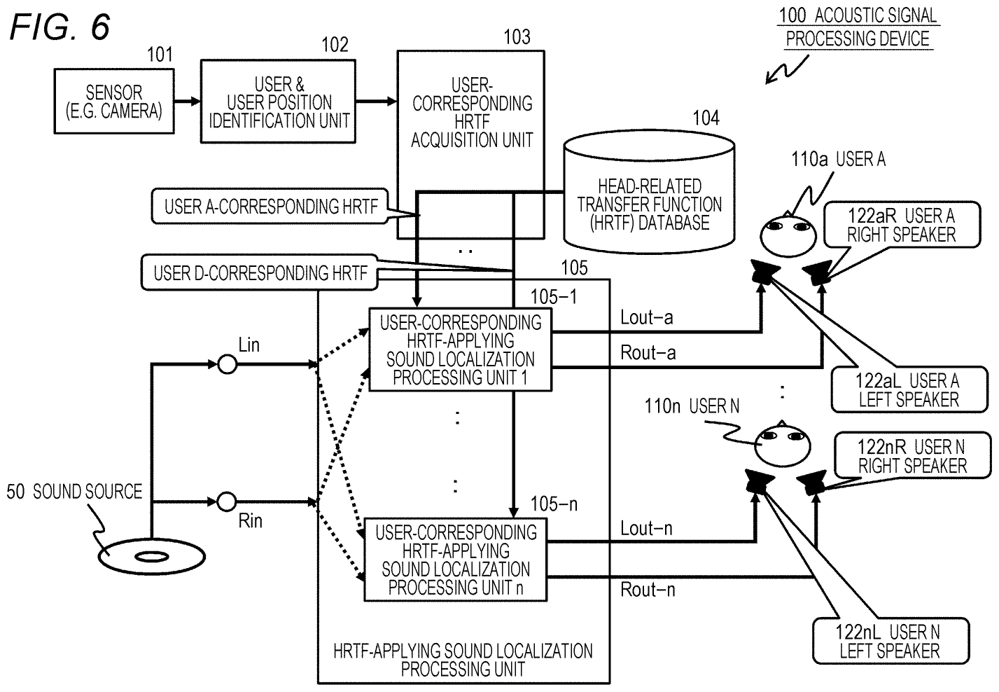

FIG. 6 is a diagram illustrating an exemplary configuration of an acoustic signal processing device 100 according to the present disclosure.

As illustrated in FIG. 6, the acoustic signal processing device 100 according to the present disclosure includes a sensor (such as a camera) 101, a user & user position identification unit 102, a user-corresponding HRTF acquisition unit 103, an HRTF database 104, and an HRTF-applying sound localization processing unit 105.

The HRTF-applying sound localization processing unit 105 includes a plurality of user-corresponding HRTF-applying sound localization processing units 105-1 to 105-n capable of executing processing in parallel.

The sensor (such as a camera) 101 is a sensor that acquires information that can be used to identify the user and the user position, and includes, for example, a camera.

Sensor detection information acquired by the sensor (such as a camera) 101, such as an image captured by a camera for example, is inputted into the user & user position identification unit 102.

The user & user position identification unit 102 identifies the user and the user position on the basis of sensor detection information acquired by the sensor (such as a camera) 101, such as an image captured by a camera for example.

As an example, the user & user position identification unit 102 identifies the user by comparing a face image included in the image captured by a camera to user face image information stored in a user database not illustrated.

Furthermore, the user & user position identification unit 102 also identifies the position of each identified user. The identification of the user position is performed as a process of determining the position where each user is located to hear the sound output from which speakers.

The user identification information and user position identification information generated by the user & user position identification unit 102 are inputted into the user-corresponding HRTF acquisition unit 103.

The user-corresponding HRTF acquisition unit 103 acquires the head-related transfer function (HRTF) corresponding to each identified user from the HRTF database 104, on the basis of the user identification information inputted from the user & user position identification unit 102.

The head-related transfer function (HRTF) corresponding to each user measured in advance is stored in the HRTF database 104.

In the HRTF database 104, the head-related transfer function (HRTF) corresponding to each user is stored in association with a user identifier. Note that the head-related transfer function (HRTF) corresponding to each user is measurable by the process described with reference to FIG. 2 above.

The user-corresponding HRTF acquisition unit 103 outputs the head-related transfer function (HRTF) corresponding to each identified user acquired from the HRTF database 104 in association with the user identification information and the user position identification information inputted from the user & user position identification unit 102.

As described above, the HRTF-applying sound localization processing unit 105 includes a plurality of user-corresponding HRTF-applying sound localization processing units 105-1 to 105-n.

Each of the plurality of user-corresponding HRTF-applying sound localization processing units 105-1 to 105-n is pre-associated with LR speakers that respectively output processed signals (Lout, R-out).

For example, the user-corresponding HRTF-applying sound localization processing unit 105-1 is connected to the LR speakers of the driver's seat, namely the user A left speaker 122aL and the user A right speaker 122aR of the driver's seat where the user A 110a illustrated in FIG. 5 is sitting.

In this way, each of the user-corresponding HRTF-applying sound localization processing units 105-1 to 105-n is pre-associated with LR speakers that respectively output processed signals (Lout, R-out).

The HRTF-applying sound localization processing unit 105 executes signal processing applying the HRTF corresponding to each user in the user-corresponding HRTF-applying sound localization processing units 105-1 to 105-n on the basis of the data associating the user identification information and the user position identification information inputted from the user-corresponding HRTF acquisition unit 103 with the head-related transfer function (HRTF) corresponding to each identified user.

Specifically, for example, the user-corresponding HRTF-applying sound localization processing unit 105-1, which is connected to the user A left speaker 122aL and the user A right speaker 122aR of the driver's seat where the user A 110a is sitting, executes signal processing (sound localization processing) that accepts the head-related transfer function (HRTF) corresponding to the user A as input.

Output signals (Lout-a, Rout-a) are generated by the signal processing. The generated output signals (Lout-a, Rout-a) are output from the user A left speaker 122aL and the user A right speaker 122aR of the driver's seat where the user A 110a is sitting.

Similarly, the user-corresponding HRTF-applying sound localization processing unit 105-n, which is connected to the user N left speaker 122nL and the user N right speaker 122nR of the driver's seat where the user N 110n illustrated in FIG. 6 is sitting, executes signal processing (sound localization processing) that accepts the head-related transfer function (HRTF) corresponding to the user N as input.

Output signals (Lout-n, Rout-n) are generated by the signal processing. The generated output signals (Lout-n, Rout-n) are output from the user N left speaker 122nL and the user N right speaker 122nR of the driver's seat where the user N 110n is sitting.

The same applies to the other users, and output signals (Lout-x, Rout-x) generated by signal processing (sound localization processing) applying the head-related transfer function (HRTF) corresponding to each user are output from the speakers at each user's position.

Through these processes, all users are able to listen to the signals (Lout-x, Rout-x) obtained by executing sound localization processing applying each user's own head-related transfer function (HRTF) from the speakers in the headrest part at the position where each user is sitting, and listen to sounds from an optimal virtual sound source position for each user.

Note that the exemplary configuration of the acoustic signal processing device 100 illustrated in FIG. 6 is an example, and other configurations are also possible.

For example, it is also possible to place the HRTF database 104 of the acoustic signal processing device 100 illustrated in FIG. 6 on an external server.

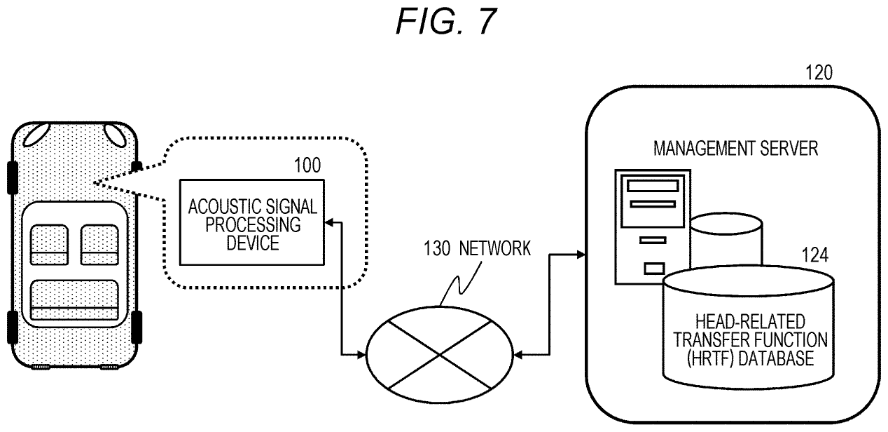

This exemplary configuration is illustrated in FIG. 7.

As illustrated in FIG. 7, the acoustic output device 100 built into an automobile is configured to be connected over a network 130 and capable of communication with a management server 120.

The acoustic output device 100 built into an automobile does not include the HRTF database 104 described with reference to FIG. 6.

The HRTF database 104 is held in the management server 120.

The management server 120 includes the HRTF database 104 that stores the head-related transfer function (HRTF) corresponding to each user measured in advance. In the HRTF database 104, the head-related transfer function (HRTF) corresponding to each user is stored in association with a user identifier.

The acoustic output device 100 executes a process of searching the HRTF database 104 in the management server 120 to acquire the head-related transfer function (HRTF) corresponding to each user on the basis of the user identification information generated by the user & user position identification unit 102.

The processes thereafter are similar to the processes described with reference to FIG. 6.

In this way, by placing the HRTF database 104 in the management server 120, it is possible to perform signal processing applying the head-related transfer functions (HRTFs) of a greater number of users.

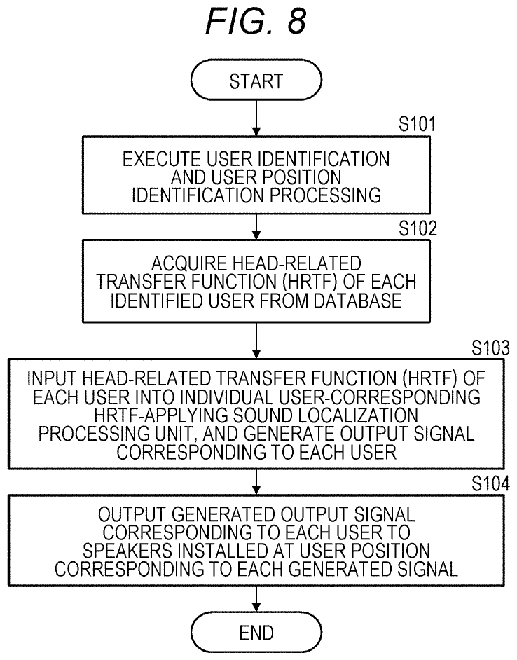

Next, the flowchart illustrated in FIG. 8 will be referenced to describe a sequence of processes executed by an acoustic signal processing device according to the present disclosure.

Note that the processes following the flows in FIGS. 8 and subsequent drawings described hereinafter may be executed according to a program stored in a storage unit of the acoustic signal processing device, for example, and are executed under the control of a control unit having a program execution function, such as a CPU for example. Hereinafter, the process in each step of the flow illustrated in FIG. 8 will be described consecutively.

(Step S101)

First, in step S101, the acoustic signal processing device executes user identification and user position identification.

This process is executed by the user & user position identification unit 102 illustrated in FIG. 6.

The user & user position identification unit 102 identifies the user and the user position on the basis of sensor detection information acquired by the sensor (such as a camera) 101, such as an image captured by a camera for example.

As an example, the user & user position identification unit 102 identifies the user by comparing a face image included in the image captured by a camera to user face image information stored in a user database not illustrated.

Furthermore, the user & user position identification unit 102 also identifies the position of each identified user. The identification of the user position is performed as a process of determining the position where each user is located to hear the sound output from which speakers.

(Step S102)

Next, in step S102, the acoustic signal processing device acquires the head-related transfer function (HRTF) of each identified user from a database.

This process is executed by the user-corresponding HRTF acquisition unit 103 illustrated in FIG. 6.

The user-corresponding HRTF acquisition unit 103 acquires the head-related transfer function (HRTF) corresponding to each identified user from the HRTF database 104, on the basis of the user identification information inputted from the user & user position identification unit 102.

In the HRTF database 104, the head-related transfer function (HRTF) corresponding to each user is stored in association with a user identifier.

The user-corresponding HRTF acquisition unit 103 executes a database search process based on the user identification information inputted from the user & user position identification unit 102, and acquires the head-related transfer function (HRTF) corresponding to each identified user.

(Step S103)

Next, in step S103, the acoustic signal processing device inputs the head-related transfer function (HRTF) of each user into respective user-corresponding HRTF-applying sound localization processing units, and generates an output signal corresponding to each user.

This process is executed by the HRTF-applying sound localization processing unit 105 illustrated in FIG. 6.

As described with reference to FIG. 6, the HRTF-applying sound localization processing unit 105 includes a plurality of user-corresponding HRTF-applying sound localization processing units 105-1 to 105-n.

Each of the plurality of user-corresponding HRTF-applying sound localization processing units 105-1 to 105-n is pre-assigned with LR speakers that respectively output processed signals (Lout, R-out).

The HRTF-applying sound localization processing unit 105 executes signal processing applying the HRTF corresponding to each user in the user-corresponding HRTF-applying sound localization processing units 105-1 to 105-n on the basis of the data associating the user identification information and the user position identification information inputted from the user-corresponding HRTF acquisition unit 103 with the head-related transfer function (HRTF) corresponding to each identified user.

(Step S104)

Finally, in step S104, the acoustic signal processing device outputs the generated output signal corresponding to each user to speakers installed at the user position corresponding to each generated signal.

This process is also executed by the HRTF-applying sound localization processing unit 105 illustrated in FIG. 6.

Output signals (Lout-x, Rout-x) generated by signal processing (sound localization processing) applying the head-related transfer function (HRTF) corresponding to each user are output from the speakers at each user's position.

Through these processes, all users are able to listen to the signals (Lout-x, Rout-x) obtained by executing sound localization processing applying each user's own head-related transfer function (HRTF) from the speakers in the headrest part at the position where each user is sitting, and listen to sounds from an optimal virtual sound source position for each user.

### 3. Embodiment in which Output Control According to Presence or Absence of User is Executed

Next, as Embodiment 2, an embodiment output control according to the presence or absence of a user is executed will be described.

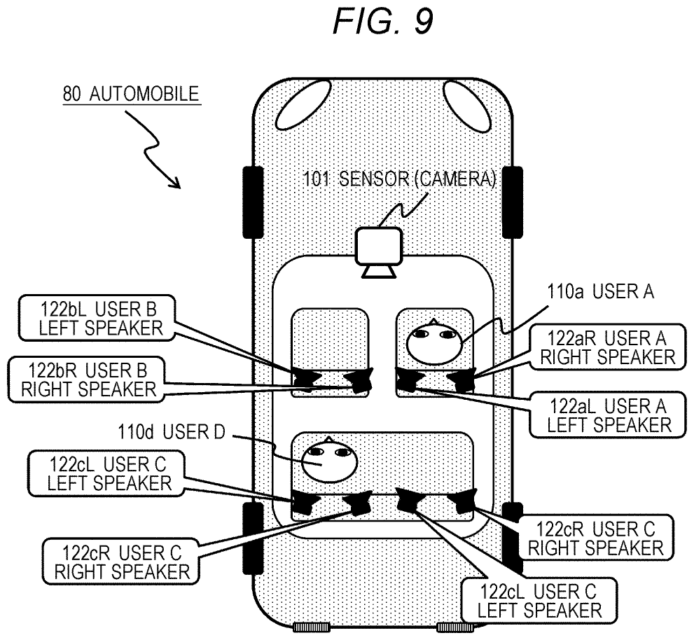

In the example described above with reference to FIG. 5, all users (listeners) are sitting in seats where speakers of the automobile 80 are installed. However, in actuality, some of the seats may be empty in many cases, for example, as illustrated in FIG. 9.

In such cases, outputting sounds from the speakers in the empty seats leads to increased power consumption. Moreover, if the output sounds from these speakers enter the ears of a user sitting in another seat, the user will perceive the sounds as unwanted noise.

The embodiment described hereinafter addresses such a problem, and is an embodiment the output from speakers at positions where no user is present is controlled to stop or mute.

A processing sequence according to Embodiment 2 will be described with reference to the flowchart illustrated in FIG. 10.

Hereinafter, the process in each step of the flow illustrated in FIG. 10 will be described consecutively.

The flow illustrated in FIG. 10 is obtained by adding steps S101a and S101b between step S101 and step S102 of the flow illustrated in FIG. 8 described above.

The processes in the other steps (step S101 and steps S102 to S104) are similar to the processes described with reference to FIG. 8 and therefore a description is omitted.

Hereinafter, the process in step S101a and the process in step S101b will be described.

(Step S101a)

In step S101, the acoustic signal processing device executes user identification and user position identification, and then executes processing of step S101a.

In step S101a, the acoustic signal processing device determines whether or not a speaker-installed seat without a user present exists.

This process is executed by the user & user position identification unit 102 illustrated in FIG. 6.

The user & user position identification unit 102 identifies the user and the user position on the basis of sensor detection information acquired by the sensor (such as a camera) 101, such as an image captured by a camera for example. At this time, it is determined whether or not a speaker-installed seat without a user present exists.

In the case where a speaker-installed seat without a user present does not exist, the flow proceeds to step S102, and the processes in steps S102 to S104 are executed.

These processes are similar to the processes described above with reference to FIG. 8, and signals obtained by performing signal processing (sound localization processing) corresponding to each user are output from the speakers in all seats.

On the other hand, in the case of determining that a speaker-installed seat without a user present exists in the determination process of step S101a, the flow proceeds to step S101b.

(Step S101b)

In the case of determining that a speaker-installed seat without a user present exists in the determination process of step S101a, the flow proceeds to step S101b.

In step S101b, the acoustic signal processing device stops the output or executes a mute control on the output from each speaker-installed seat without a user present.

This process is executed by the HRTF-applying sound localization processing unit 105 illustrated in FIG. 6.

In the case of stopping the output, the generation of output sounds for the speakers in these seats is not executed either. Among the user-corresponding HRTF-applying sound localization processing units 105-1 to 105-n of the HRTF-applying sound localization processing unit 105 illustrated in FIG. 6, the processing units that generate output sounds for speakers without a user present do not execute any processing.

Also, in the case of executing a mute control, output sounds are generated to be limited to playback sounds at a level that is inaudible to the ears of nearby users. Note that the HRTF to apply to the signal processing (sound localization processing) in this case is an HRTF of standard type stored in the HRTF database 104.

Alternatively, playback sounds may be output directly from the sound source without executing signal processing (sound localization processing).

Thereafter, in steps S102 to S104, the signal processing and outputting of playback sounds is executed only for the speakers at positions where a user is present in the seat.

By performing these processes, the output from speakers at positions without a user present is stopped or muted, and a reduction in power consumption is achieved. Furthermore, it is possible to reduce noise entering the ears of the users in other seats.

### 4. Other Embodiments

The embodiment described above describes an acoustic output control configuration inside an automobile, but the processes according to the present disclosure are otherwise usable in a variety of places.

Hereinafter, an embodiment in which the present disclosure is applied to seats on an airplane, an embodiment in which the present disclosure is applied to an attraction at an amusement park, and an embodiment in which the present disclosure is applied to an art museum will be described.

### (a) Embodiment in which the Present Disclosure is Applied to Seats on an Airplane

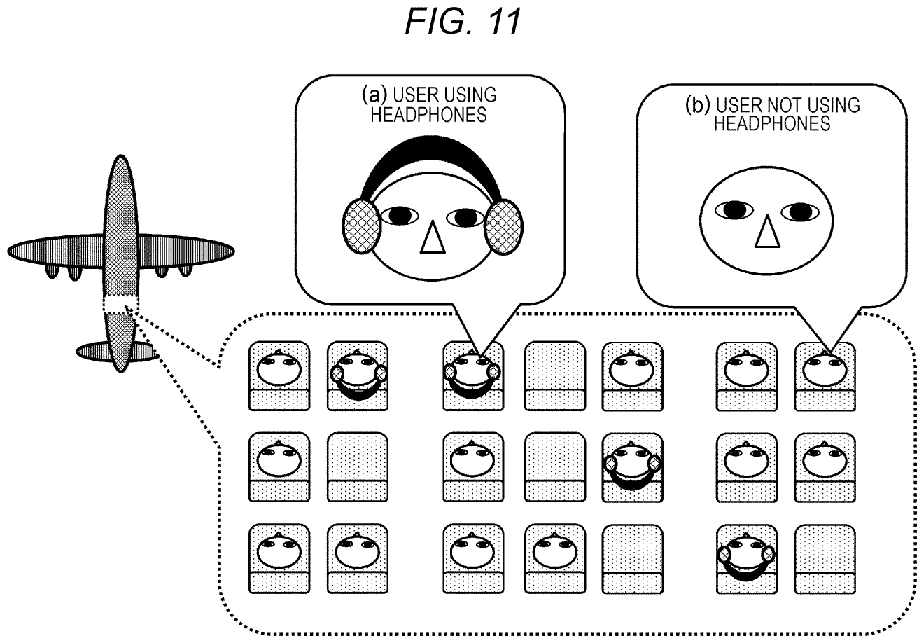

First, with reference to FIG. 11 and subsequent drawings, an embodiment in which the acoustic signal processing device according to the present disclosure is applied to a seat on an airplane will be described.

Seats on an airplane are equipped with a socket for inserting headphones (headphone jack), and users (passengers) sitting in the seats are able to listen to music and the like by plugging in headphones.

As illustrated in FIG. 11, some seats are filled by users (passengers) while other seats are empty. Moreover, some users are using headphones while other users are not.

The seats are assigned, and the seat where each user sits is predetermined.

A record of which user sits in which seat is recorded in a database in a boarding reservation system.

In the case of such settings, an acoustic signal processing device onboard an airplane is capable of checking the seat position of each user (passenger) on the basis of the record data in the boarding reservation system.

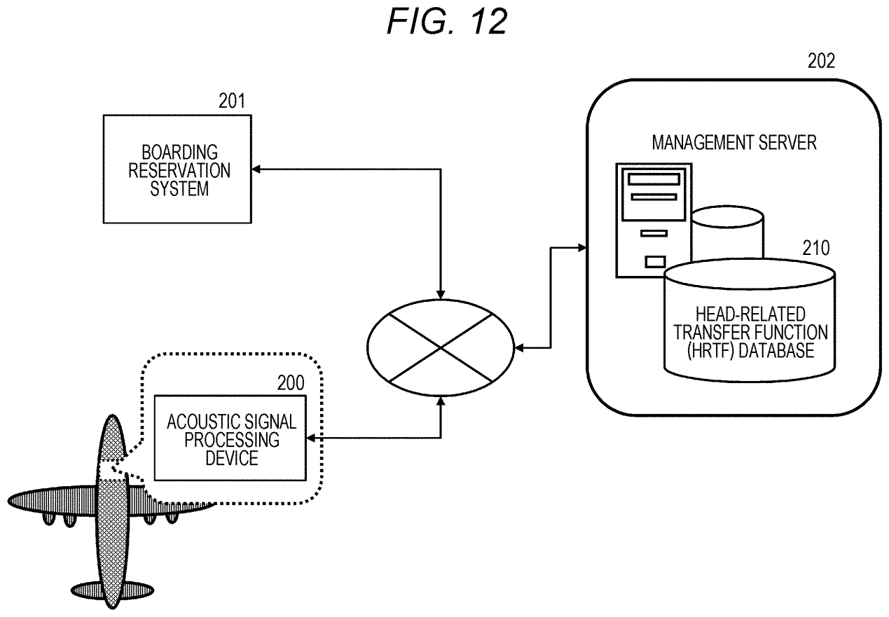

FIG. 12 illustrates an exemplary system configuration according to the present embodiment.

An acoustic signal processing device 200 onboard an airplane is connected to a boarding reservation system 201 and a management server 202 over a network.

Note that the management server 202 includes an HRTF database 210 in which the head-related transfer function (HRTF) of each user (passenger) is recorded. The acoustic signal processing device 200 onboard an airplane has a configuration substantially similar to the configuration described above with reference to FIG. 6.

However, the configuration omits the HRTF database 104, and also does not include the sensor 101. User identification and user position identification is executed using record data in the boarding reservation system 201 connected over the network.

A user & user position identification unit (that is, the user & user position identification unit 102 illustrated in FIG. 6) of the acoustic signal processing device 200 onboard an airplane identifies the user at each seat position on the basis of the boarding reservation system 201 connected over the network. Specifically, a user identifier of the user who reserved each seat position is acquired.

Furthermore, a user-corresponding HRTF acquisition unit (that is, the user-corresponding HRTF acquisition unit 103 illustrated in FIG. 6) of the acoustic signal processing device 200 acquires the head-related transfer function (HRTF) corresponding to each user from the HRTF database 210 of the management server 202 on the basis of the user identifier for each seat position.

Next, the acoustic signal processing device 200 generates output sounds through the headphone jack in each set. The generation of output sounds is a process executed by an HRTF-applying sound localization processing unit (that is, the HRTF-applying sound localization processing unit 105 illustrated in FIG. 6) of the acoustic signal processing device 200.

As described with reference to FIG. 6, the HRTF-applying sound localization processing unit 105 includes a plurality of user-corresponding HRTF-applying sound localization processing units 105-1 to 105-n.

Each of the plurality of user-corresponding HRTF-applying sound localization processing units 105-1 to 105-n is pre-assigned with the headphone jack that respectively output processed signals (Lout, R-out).

The HRTF-applying sound localization processing unit 105 executes signal processing in the user-corresponding HRTF-applying sound localization processing units 105-1 to 105-n on the basis of the data associating the user (seat) identification information and the user position identification information inputted from the user-corresponding HRTF acquisition unit 103 with the head-related transfer function (HRTF) corresponding to each identified user.

In each of the user-corresponding HRTF-applying sound localization processing units 105-1, signal processing applying the HRTF corresponding to each identified user is executed to generate a sound localization processed signal corresponding to each user. The signal corresponding to each user is output as output sounds from the headphone jack at the seat position of each user.

Through this process, the users who are passengers on the airplane are able to listen to signals that have been subjected to processing (sound localization processing) on the basis of each user's own head-related transfer function (HRTF), and are able to listen to sounds from an ideal virtual sound source position.

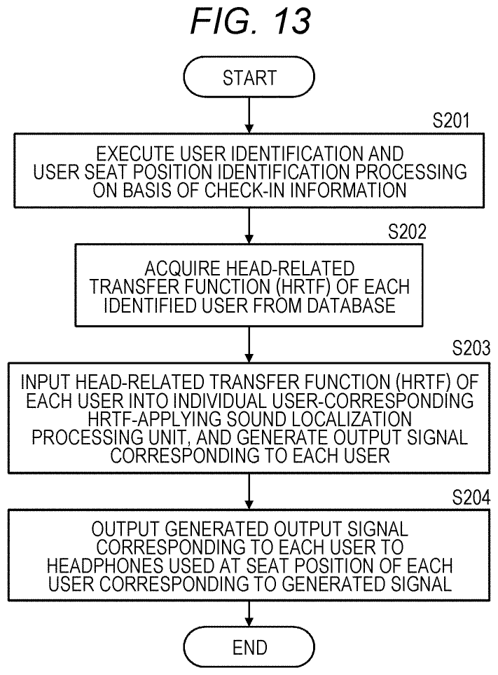

Next, the flowchart illustrated in FIG. 13 will be referenced to describe a sequence of processes executed by an acoustic signal processing device according to the present embodiment.

Hereinafter, the process in each step of the flow illustrated in FIG. 13 will be described consecutively.

(Step S201)

First, in step S201, the acoustic signal processing device executes user identification and user position identification on the basis of check-in information.

This process is executed by a user & user position identification unit (that is, the user & user position identification unit 102 illustrated in FIG. 6) of the acoustic signal processing device 200 onboard the airplane illustrated in FIG. 12.

A user & user position identification unit of the acoustic signal processing device 200 identifies the user at each seat position on the basis of the boarding reservation system 201 connected over the network. Specifically, a user identifier of the user who reserved each seat position is acquired.

(Step S202)

Next, in step S202, the acoustic signal processing device acquires the head-related transfer function (HRTF) of each identified user from a database.

This process is executed by a user-corresponding HRTF acquisition unit (that is, the user-corresponding HRTF acquisition unit 103 illustrated in FIG. 6) of the acoustic signal processing device 200.

The user-corresponding HRTF acquisition unit acquires the head-related transfer function (HRTF) corresponding to each user from the HRTF database 210 of the management server 202 on the basis of the user identifier of the user who reserved each seat.

(Step S203)

Next, in step S203, the acoustic signal processing device inputs the head-related transfer function (HRTF) of each user into respective user-corresponding HRTF-applying sound localization processing units, and generates an output signal corresponding to each user.

This process is executed by the HRTF-applying sound localization processing unit 105 illustrated in FIG. 6.

Each of the plurality of user-corresponding HRTF-applying sound localization processing units 105-1 to 105-n generates an output signal corresponding to a user by executing signal processing (sound localization processing) that treats the head-related transfer function (HRTF) corresponding to each user at each seat position as a processing parameter.

(Step S204)

Finally, in step S204, the acoustic signal processing device outputs the generated output signal corresponding to each user as an output signal from the headphone jack at the seat position of each user corresponding to the generated signal.

The output from the headphone jack at the seat position of each user is output signals (Lout-x, Rout-x) generated by signal processing (sound localization processing) applying the head-related transfer function (HRTF) corresponding to each user.

Through these processes, all users (passengers) are able to listen to the signals (Lout-x, Rout-x) obtained by executing sound localization processing applying each user's own head-related transfer function (HRTF) at the seat position where each user is sitting, and listen to sounds from an optimal virtual sound source position for each user.

### (b) Embodiment in which the Present Disclosure is Applied to Attraction at Amusement Park

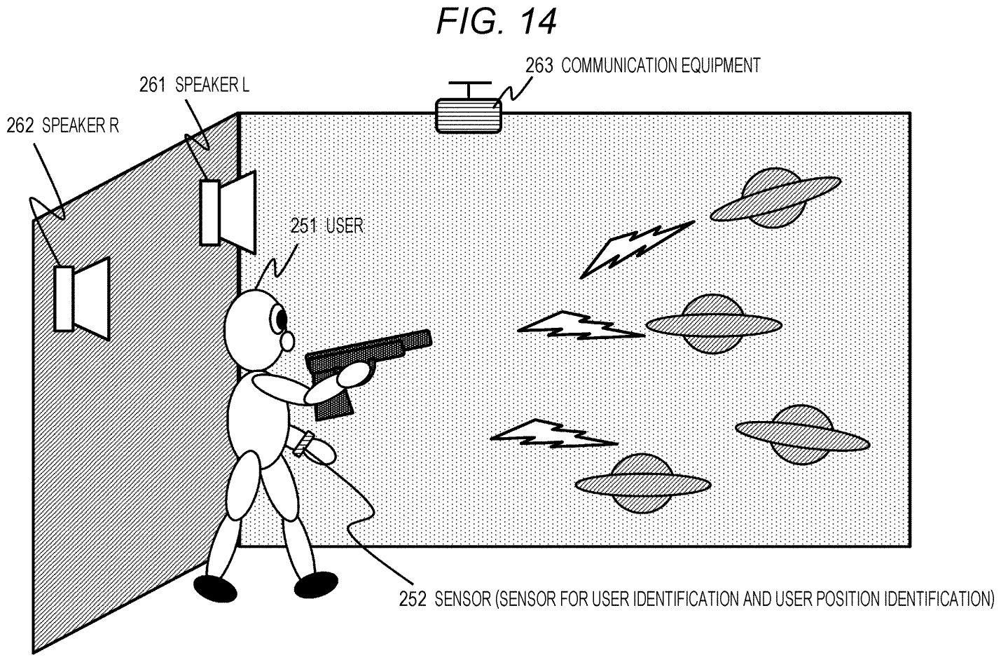

Next, with reference to FIG. 14, an embodiment in which the acoustic signal processing device according to the present disclosure is applied to an attraction at an amusement park will be described.

FIG. 14 illustrates a user 251 playing an attraction at an amusement park.

When the user 251 buys a ticket at the entrance to the amusement park, user information is registered, and during the registration process the user receives a sensor 252 storing a user identifier to wear on the user's arm.

The sensor 252 communicates with communication equipment 263 installed at various locations inside the amusement park, and transmits the user identifier to an acoustic signal processing device disposed in a management center of the amusement park. The acoustic signal processing device disposed in the management center of the amusement park has a configuration substantially similar to the configuration described above with reference to FIG. 6.

However, the user & user position identification unit 102 receives user identification information and user position information from the sensor 252 worn by the user 251 illustrated in FIG. 14 through the communication equipment 263, and identifies each user and the position of each user.

As illustrated in FIG. 14, a plurality of speakers, such as a speaker L 261 and a speaker R 262, is installed in each attraction.

The acoustic signal processing device disposed in the management center of the amusement park uses the output from these speakers as a processed signal (sound localization processed signal), in which the head-related transfer function (HRTF) of the user 251 in front of the speakers has been applied as a processing parameter.

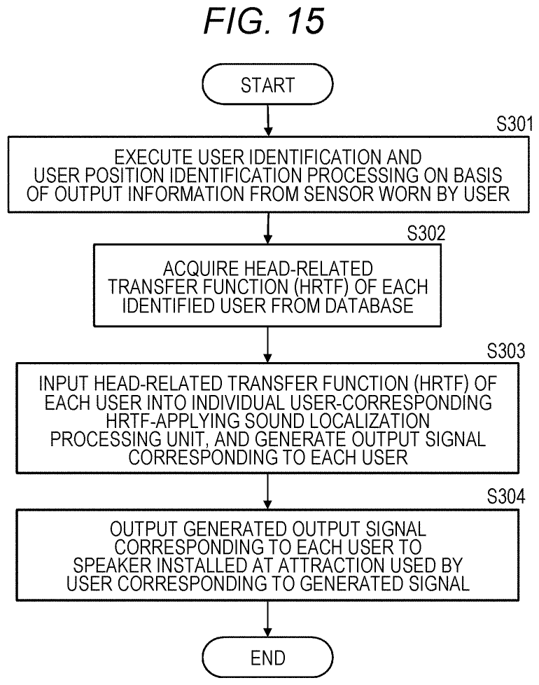

The flowchart illustrated in FIG. 15 will be referenced to describe a sequence of processes executed by an acoustic signal processing device according to the present embodiment.

Hereinafter, the process in each step of the flow illustrated in FIG. 15 will be described consecutively.

(Step S301)

First, in step S301, the acoustic signal processing device executes user identification and user position identification on the basis of a received signal from the sensor 252 worn by the user.

This process is executed by a user & user position identification unit (that is, the user & user position identification unit 102 illustrated in FIG. 6) of the acoustic signal processing device in the management center of the amusement park.

The user & user position identification unit of the acoustic signal processing device executes user identification and user position identification by receiving the output of the sensor 252 worn by the user illustrated in FIG. 14 through the communication equipment 263.

(Step S302)

Next, in step S302, the acoustic signal processing device acquires the head-related transfer function (HRTF) of each identified user from a database.

This process is executed by a user-corresponding HRTF acquisition unit (that is, the user-corresponding HRTF acquisition unit 103 illustrated in FIG. 6) of the acoustic signal processing device in the management center of the amusement park.

The user-corresponding HRTF acquisition unit acquires the head-related transfer function (HRTF) corresponding to each user from the HRTF database on the basis of the user identifier of the user in each attraction.

Note that the HRTF database may be stored in the acoustic signal processing device in the management center of the amusement park in some cases, or may be stored in a management server connected over a network in other cases.

(Step S303)

Next, in step S303, the acoustic signal processing device inputs the head-related transfer function (HRTF) of each user into respective user-corresponding HRTF-applying sound localization processing units, and generates an output signal corresponding to each user.

This process is executed by the HRTF-applying sound localization processing unit 105 illustrated in FIG. 6.

Each of the plurality of user-corresponding HRTF-applying sound localization processing units 105-1 to 105-n generates an output signal corresponding to a user by executing signal processing (sound localization processing) that treats the head-related transfer function (HRTF) corresponding to each user at each attraction position as a processing parameter.

(Step S304)

Finally, in step S304, the acoustic signal processing device outputs the generated output signal corresponding to each user as an output signal from the speaker at the attraction position of each user corresponding to the generated signal.

The output from the speakers at each attraction is output signals (Lout-x, Rout-x) generated by signal processing (sound localization processing) applying the head-related transfer function (HRTF) corresponding to the user playing the attraction.

Through these processes, users playing the attraction are able to listen to the signals (Lout-x, Rout-x) obtained by executing sound localization processing applying each user's own head-related transfer function (HRTF), and listen to sounds from an optimal virtual sound source position for each user.

### (c) Embodiment in which the Present Disclosure is Applied to Art Museum

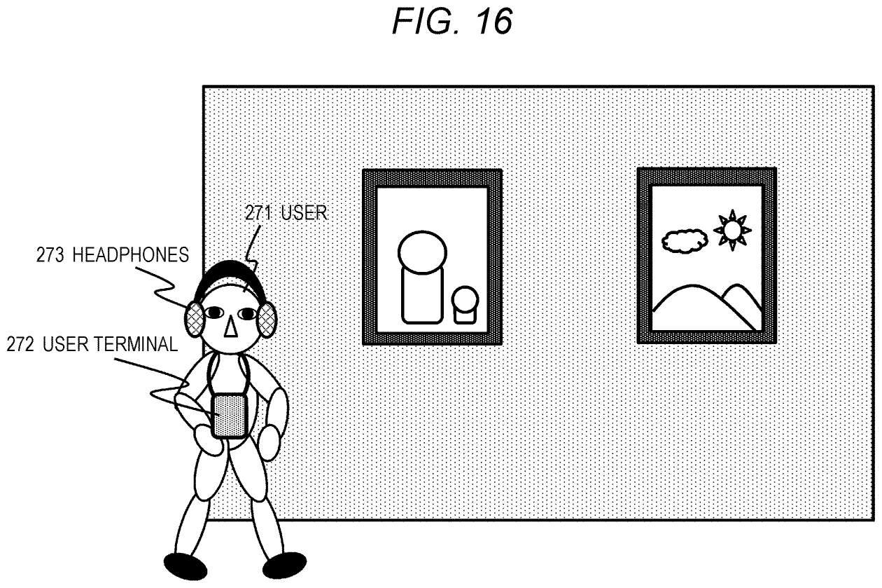

Next, with reference to FIG. 16 and subsequent drawings, an embodiment in which the acoustic signal processing device according to the present disclosure is applied to an art museum will be described.

FIG. 16 illustrates a user 271 visiting an art museum.

When the user 271 buys a ticket at the entrance to the art museum, user information is registered, and during the registration process the user receives a user terminal 272 storing a user identifier.

The user terminal 272 is provided with a headphone jack, and by inserting a plug of headphones 273 into the headphone jack, the user 271 is able to listen to various commentary from the headphones.

The user terminal 272 is capable of communicating with an acoustic signal processing device disposed in a management center of the art museum.

The acoustic signal processing device disposed in the management center of the art museum has a configuration substantially similar to the configuration described above with reference to FIG. 6.

However, the user & user position identification unit 102 receives user identification information and user position information from the user terminal 272 worn by the user 271 illustrated in FIG. 16, and identifies each user and the position of each user.

Note that in the case where a membership database storing registered membership information exists, for example, the database registration information may also be used for user identification.

Furthermore, the acoustic signal processing device disposed in the management center of the art museum uses the output from the headphones 273 used by the user 271 as a processed signal (sound localization processed signal), in which the head-related transfer function (HRTF) of the user 271 has been applied as a processing parameter.

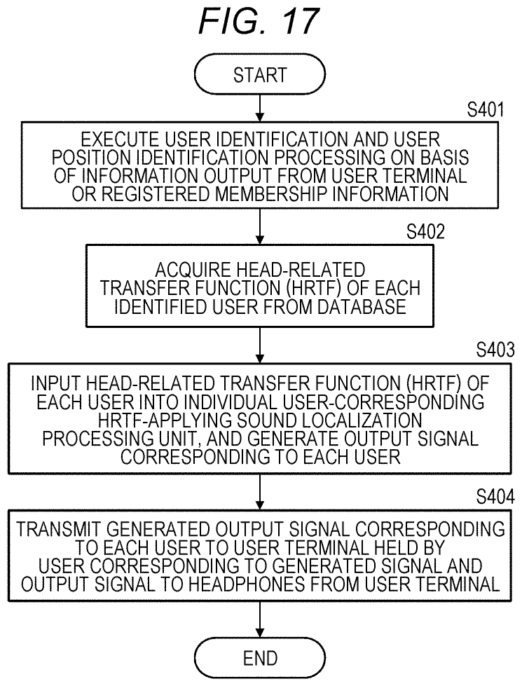

The flowchart illustrated in FIG. 17 will be referenced to describe a sequence of processes executed by an acoustic signal processing device according to the present embodiment.

Hereinafter, the process in each step of the flow illustrated in FIG. 17 will be described consecutively.

(Step S401)

First, in step S401, the acoustic signal processing device executes user identification and user position identification on the basis of a received signal from the user terminal 272 worn by the user or registered membership information.

This process is executed by a user & user position identification unit (that is, the user & user position identification unit 102 illustrated in FIG. 6) of the acoustic signal processing device in the management center of the art museum.

The user & user position identification unit of the acoustic signal processing device executes user identification and user position identification by receiving the output of the user terminal 272 worn by the user illustrated in FIG. 16. Note that user identification may also be executed using registered membership information, such as a membership database that is referenced during a check when entering the art museum, for example.

(Step S402)

Next, in step S402, the acoustic signal processing device acquires the head-related transfer function (HRTF) of each identified user from a database.

This process is executed by a user-corresponding HRTF acquisition unit (that is, the user-corresponding HRTF acquisition unit 103 illustrated in FIG. 6) of the acoustic signal processing device in the management center of the art museum.

The user-corresponding HRTF acquisition unit acquires the head-related transfer function (HRTF) corresponding to each user from the HRTF database on the basis of the user identifier of the user.

Note that the HRTF database may be stored in the acoustic signal processing device in the management center of the art museum in some cases, or may be stored in a management server connected over a network in other cases.

(Step S403)

Next, in step S403, the acoustic signal processing device inputs the head-related transfer function (HRTF) of each user into respective user-corresponding HRTF-applying sound localization processing units, and generates an output signal corresponding to each user.

This process is executed by the HRTF-applying sound localization processing unit 105 illustrated in FIG. 6.

Each of the plurality of user-corresponding HRTF-applying sound localization processing units 105-1 to 105-n generates an output signal corresponding to a user by executing signal processing (sound localization processing) that treats the head-related transfer function (HRTF) corresponding to each user at various locations in the art museum as a processing parameter.

(Step S304)

Finally, in step S404, the acoustic signal processing device transmits the generated output signal corresponding to each user to the user terminal 272 of the user corresponding to the generated signal as an output signal from the headphones 273 plugged into the user terminal 272.

The output from the headphones 273 plugged into the user terminal 272 carried by the user at various locations inside the art museum is output signals (Lout-x, Rout-x) generated by signal processing (sound localization processing) applying the head-related transfer function (HRTF) corresponding to the user.

Through these processes, users at various locations inside the art museum are able to listen to the signals (Lout-x, Rout-x) obtained by executing sound localization processing applying each user's own head-related transfer function (HRTF), and listen to sounds from an optimal virtual sound source position for each user.

Note that, although the embodiment described above illustrates an example in which the acoustic signal processing device disposed in the management center of the art museum generates the sound localization processed signal, the signal processing (sound localization processing) applying the head-related transfer function (HRTF) corresponding to each user may also be configured to be performed in the user terminal 272 carried by each user, for example.

### (d) Embodiment in which Sound Localization Processing Using Signal Processing Other than Head-Related Transfer Function (HRTF) is Performed

Although the foregoing describes embodiments in which sound localization processing using the head-related transfer function (HRTF) is performed, it is also possible to perform sound localization processing by signal processing using data other than the head-related transfer function (HRTF).

For example, parameters that determine the head-related transfer function (HRTF) or an approximate value thereof are applicable to the signal processing. The parameters are, for example:

(1) an approximation of the head-related transfer function (HRTF),

(2) a parameter that determines the head-related transfer function (HRTF), and

(3) a parameter that determines an approximation of the head-related transfer function (HRTF).

Specifically, it is possible to use information such as the Fq, Gain, and Q in the case of reproducing the HRTF through EQ.

Additionally, it is also possible to use data based on individual physical characteristics that are used in signal processing other than sound localization processing, such as a filter used for individual optimization of noise canceling, for example.

Furthermore, data based on individual preferences, such as EQ parameters for adjusting the sound quality and the volume for example may also be used.

### 5. Embodiment in which Head-Related Transfer Function (HRTF) Specific to User in User Terminal is Stored

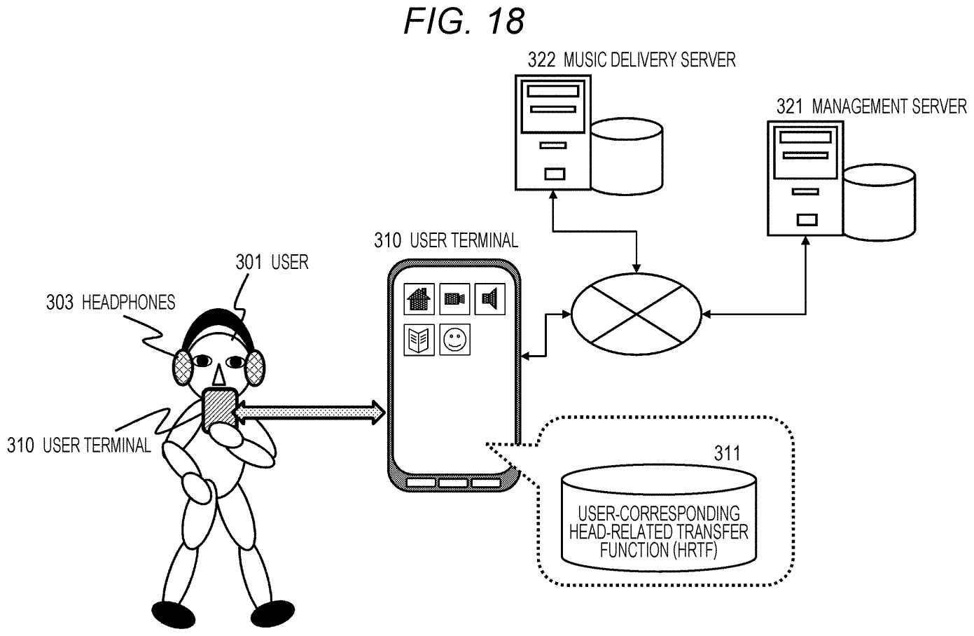

Next, with reference to FIG. 18 and subsequence drawings, an embodiment in which the head-related transfer function (HRTF) specific to a user in a user terminal is stored will be described.

The foregoing describes embodiments in which the head-related transfer functions (HRTFs) of various users are stored in an HRTF database.

In contrast, the embodiment described with reference to FIG. 18 and subsequent drawings is an embodiment in which the head-related transfer function (HRTF) 311 unique to a specific user 301 is stored in a user terminal 310 carried by the user 301.

The user terminal 310 outputs an audio signal to headphones 303 wirelessly or through a headphone jack. The user 301 listens to audio output from the headphones 303.

The output sounds from the headphones 303 are signals processed by signal processing (sound localization processing) applying the head-related transfer function (HRTF) 311 unique to the user 301.

For example, the user 301 receives music provided by a music delivery server 322 by downloading or streaming to the user terminal 310.

The user terminal 310 performs signal processing (sound localization processing) applying the user-corresponding head-related transfer function (HRTF) 311 unique to the user 301 stored in the user terminal 310 to an audio signal acquired from the music delivery server 322, and outputs a processed audio signal to the headphones 303.

With this arrangement, an audio signal that has been subjected to sound localization processing applying the head-related transfer function (HRTF) unique to the user can be heard.

However, in the case of performing signal processing (sound localization processing) in a signal processing unit inside the user terminal 310, it may be necessary, in some cases, to acquire authorization information from a management server 321.

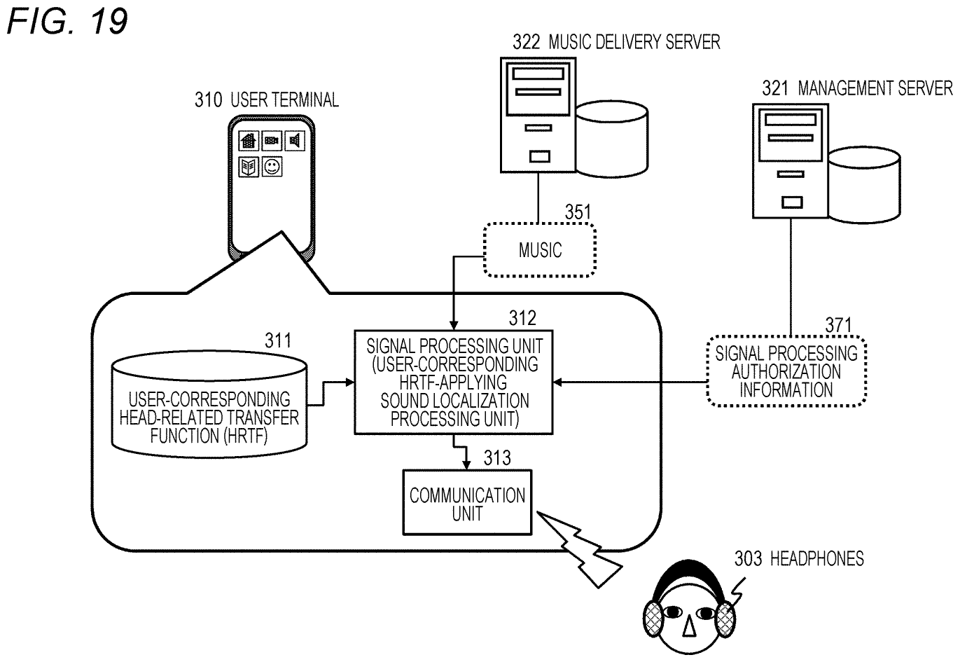

A configuration and process of the present embodiment will be described with reference to FIG. 19.

As illustrated in FIG. 19, the user terminal 310 includes the user-corresponding head-related transfer function (HRTF) 311 unique to the user carrying the user terminal 310, a signal processing unit 312 that executes signal processing (sound localization processing) applying the head-related transfer function (HRTF) unique to the user, and a communication unit 313 that outputs a processed signal from the signal processing unit 312 to the headphones 303.

Audio signals (Lin, Rin) of music 351 provided by the music delivery server 322 are inputted into the signal processing unit 312 of the user terminal 310.

The signal processing unit 312 executes signal processing (sound localization processing) applying the user-corresponding head-related transfer function (HRTF) 311 stored in a storage unit of the user terminal 310 to the audio signals acquired from the music delivery server 322.

However, in the case of performing signal processing (sound localization processing) in a signal processing unit 312, it is necessary, in some cases, to acquire authorization information from a management server 321.

The user terminal 310 acquires authorization information 371 from the management server 321. The authorization information 371 is key information or the like that enables the execution of a signal processing (sound localization processing) program in the signal processing unit 312, for example.

The user terminal 310 executes the signal processing (sound localization processing) applying the user-corresponding head-related transfer function (HRTF) 311 to the audio signals delivered from the music delivery server 322, on the condition that the authorization information 371 is acquired from the management server 321.

Processed audio signals (Lout, Rout) are output to the headphones 303 through the headphone jack or the communication unit 313.

With this arrangement, the user is able to listen to an audio signal that has been subjected to sound localization processing applying the head-related transfer function (HRTF) unique to the user.

Note that, as a configuration that stores the head-related transfer functions (HRTFs) for a plurality of different users in the user terminal 310, the user terminal may be configured such that the using user selects which head-related transfer function (HRTF) to use.

Alternatively, the user terminal may be provided with a user identification unit, and the user identification unit may be configured to execute audio output control applying the head-related transfer function (HRTF) corresponding to an identified user.

As another example, a configuration in which an audio output system such as an in-vehicle audio system communicates with the user terminal 310, the audio output system acquires the head-related transfer function (HRTF) stored in the user terminal 310, and audio output control in accordance with the acquired head-related transfer function (HRTF) is executed on the audio output system side may be taken.

Note that although the foregoing embodiments are described by taking a stereo signal as an example of the sound source, the processes according to the present disclosure are also applicable to processes performed on signals other than stereo signals, such as multi-channel signals, object-based signals that play back sounds in units of objects, and Ambisonic signals or higher-order Ambisonic signals that reproduce a sound field.

### 6. Exemplary Hardware Configuration of Acoustic Signal Processing Device, User Terminal, Server, and the Like

Next, an explanation will be given for an exemplary hardware configuration of the acoustic signal processing device, the user terminal, the server, and the like described in the embodiment above.

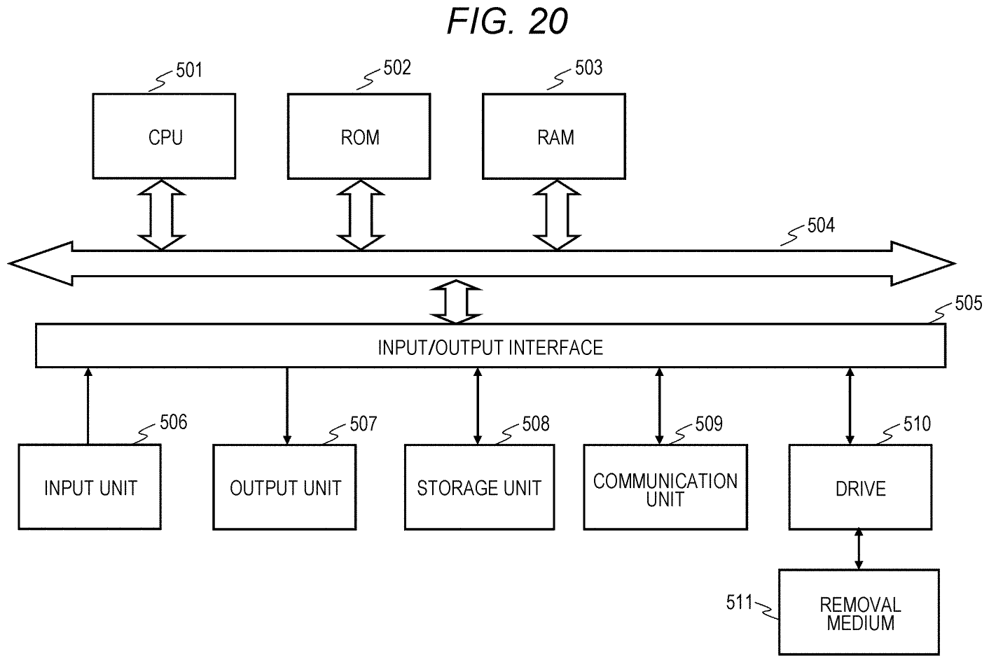

The hardware to be described with reference to FIG. 20 is an exemplary hardware configuration of the acoustic signal processing device, the user terminal, the server, and the like described in the embodiment above.

A central processing unit (CPU) 501 functions as a control unit and a data processing unit which execute various processing according to a program stored in a read only memory (ROM) 502 or a storage unit 508. For example, processing according to the sequence described in the above embodiment is executed. A random access memory (RAM) 503 stores the program executed by the CPU 501, data, and the like. The CPU 501, the ROM 502, and the RAM 503 are connected to each other by a bus 504.

The CPU 501 is connected to an input/output interface 505 via the bus 504, and the input/output interface 505 is connected to an input unit 506 including various switches, a keyboard, a mouse, a microphone, a sensor, and the like and an output unit 507 including a display, a speaker, and the like. The CPU 501 executes various processing in response to an instruction input from the input unit 506 and outputs the processing result to, for example, the output unit 507.

The storage unit 508 connected to the input/output interface 505 includes, for example, a hard disk and the like and stores the program executed by the CPU 501 and various data. A communication unit 509 functions as a transmission/reception unit of Wi-Fi communication, Bluetooth (registered trademark) (BT) communication, and other data communication via a network such as the Internet and a local area network, and communicates with an external apparatus.

A drive 510 connected to the input/output interface 505 drives a removable medium 511 such as a magnetic disk, an optical disk, a magneto-optical disk, or a semiconductor memory such as a memory card and records or reads data.

### 7. Summary of Configuration According to Present Disclosure

The embodiment of the present disclosure has been described in detail with reference to the specific embodiment above. However, it is obvious that those skilled in the art can make modifications and substitutions of the embodiments without departing from the gist of the present disclosure. In other words, the present invention has been disclosed in a form of exemplification and is not restrictively interpreted. Claims should be considered in order to determine the gist of the present disclosure.

Further, the present technology disclosed in this specification may include the following configuration.

(1) An acoustic signal processing device including:

a user identification unit that executes a user identification process;

an acquisition unit that acquires a head-related transfer function (HRTF) unique to a user identified by the user identification unit, from among one or a plurality of head-related transfer functions (HRTFs); and

a sound localization processing unit that executes sound localization processing using, as a processing parameter, the head-related transfer function (HRTF) unique to the user acquired by the acquisition unit.

(2) The acoustic signal processing device according to (1), in which

the user identification unit additionally

executes a user position identification process, and

the sound localization processing unit

outputs a signal obtained by the sound localization processing from a speaker near a user position identified in the user identification unit.

(3) The acoustic signal processing device according to (1) or (2), in which

the user identification unit

executes the user identification process with respect to a plurality of users, and

the sound localization processing unit

executes the sound localization processing, in parallel, using the head-related transfer function (HRTF) of each of the plurality of users identified in the user identification unit as a processing parameter.

(4) The acoustic signal processing device according to any one of (1) to (3), in which

the user identification unit

executes the user identification process based on an image captured by a camera or both the user identification process and a user position identification process.

(5) The acoustic signal processing device according to any one of (1) to (4), in which

the user identification unit

executes the user identification process based on sensor information or both the user identification process and a user position identification process.

(6) The acoustic signal processing device according to any one of (1) to (5), further including

a head-related transfer function (HRTF) database storing the head-related transfer function (HRTF) corresponding to each user.

(7) The acoustic signal processing device according to any one of (1) to (6), in which

the acquisition unit

accepts user identification information from the user identification unit as input, acquires the head-related transfer function (HRTF) unique to the user from a database internal to the acoustic signal processing device on the basis of the user identification information, and makes an output to the sound localization processing unit.

(8) The acoustic signal processing device according to any one of (1) to (7), in which

the acquisition unit

accepts user identification information from the user identification unit as input, acquires the head-related transfer function (HRTF) unique to the user from a database in an external server on the basis of the user identification information, and makes an output to the sound localization processing unit.

(9) The acoustic signal processing device according to any one of (1) to (8), in which

the sound localization processing unit

executes a process of stopping or reducing an output signal to a position where the user identification unit determines that a user is not present.

(10) The acoustic signal processing device according to any one of (1) to (9), in which

the user identification unit

references registered data in a boarding reservation system to execute the user identification process or both the user identification process and a user position identification process.

(11) The acoustic signal processing device according to any one of (1) to (10), in which

the user identification unit

executes the user identification process or both the user identification process and a user position identification process, on the basis of a sensor worn by the user or information received from a user terminal.

(12) The acoustic signal processing device according to any one of (1) to (11), in which

the user identification unit

references preregistered user membership information to execute the user identification process.

(13) An acoustic signal processing device including:

a storage unit storing a head-related transfer function (HRTF) unique to a user;

an acquisition unit that acquires the head-related transfer function (HRTF) unique to the user from the storage unit; and

a sound localization processing unit that executes sound localization processing using, as a processing parameter, the head-related transfer function (HRTF) unique to the user acquired by the acquisition unit.

(14) The acoustic signal processing device according to (13), in which

the sound localization processing unit

executes the sound localization processing on an acoustic signal acquired from an external server.

(15) An acoustic signal processing system including a user terminal and a server, in which

the server

transmits an audio signal to the user terminal, and

the user terminal includes

a storage unit storing a head-related transfer function (HRTF) unique to a user,

an acquisition unit that acquires the head-related transfer function (HRTF) unique to the user from the storage unit, and

a sound localization processing unit that executes sound localization processing on the audio signal received from the server using, as a processing parameter, the head-related transfer function (HRTF) unique to the user acquired by the acquisition unit.

(16) An acoustic signal processing method executed in an acoustic signal processing device, the method including:

executing, by a user identification unit, a user identification process;

acquiring, by an acquisition unit, a head-related transfer function (HRTF) unique to a user identified by the user identification unit, from among one or a plurality of head-related transfer functions (HRTFs); and

executing, by a sound localization processing unit, sound localization processing using, as a processing parameter, the head-related transfer function (HRTF) unique to the user acquired by the acquisition unit.

(17) An acoustic signal processing method executed in an acoustic signal processing device,

the acoustic signal processing device including a storage unit storing a head-related transfer function (HRTF) unique to a user, the method including:

acquiring, by an acquisition unit, the head-related transfer function (HRTF) unique to the user from the storage unit; and

executing, by a sound localization processing unit, sound localization processing using, as a processing parameter, the head-related transfer function (HRTF) unique to the user acquired by the acquisition unit.

(18) A program causing an acoustic signal processing device to execute acoustic signal processing including:

causing a user identification unit to execute a user identification process;

causing an acquisition unit to acquire a head-related transfer function (HRTF) unique to a user identified by the user identification unit, from among one or a plurality of head-related transfer functions (HRTFs); and

causing a sound localization processing unit to execute sound localization processing using, as a processing parameter, the head-related transfer function (HRTF) unique to the user acquired by the acquisition unit.

Further, the series of processes described herein can be executed by hardware, software, or a composite configuration thereof. In the case where the processes are executed by software, a program having a process sequence therefor recorded therein can be executed after being installed in a memory incorporated in dedicated hardware in a computer, or can be executed after being installed in a general-purpose computer capable of various processes. For example, such a program may be previously recorded in a recording medium. The program can be installed in the computer from the recording medium. Alternatively, the program can be received over a network such as a LAN (Local Area Network) or the internet, and be installed in a recording medium such as an internal hard disk.

Note that the processes described herein are not necessarily executed in the described time-series order, and the processes may be executed parallelly or separately, as needed or in accordance with the processing capacity of a device to execute the processes. Further, in the present description, a system refers to a logical set configuration including a plurality of devices, and the devices of the respective configurations are not necessarily included in the same casing.

### INDUSTRIAL APPLICABILITY

As described above, according to the configuration of exemplary aspects of the present disclosure, there is achieved a configuration that executes sound localization processing applying a head-related transfer function (HRTF) corresponding to a user identified by a user identification, and makes an output from an output unit for each user position.

Specifically, for example, a user identification unit that executes user identification and a user position identification process and a sound localization processing unit that executes sound localization processing using, as a processing parameter, a head-related transfer function (HRTF) specific to the user are included. The sound localization processing unit executes sound localization processing that treats the HRTF specific to the identified user as a processing parameter, and outputs a signal obtained by the sound localization processing to an output unit for the identified user position. In a case where the user identification unit identifies multiple users, the sound localization processing unit executes the sound localization processing using the HRTF of each of the multiple users in parallel, and outputs processed signals to an output unit for each user position.

According to the present configuration, there is achieved a configuration that executes sound localization processing applying a head-related transfer function (HRTF) corresponding to a user identified by a user identification, and makes an output from an output unit for each user position.

### REFERENCE SIGNS LIST

1 Automobile
10 User
21 Left speaker
22 Right speaker
31 Virtual left speaker
32 Virtual right speaker
41 Real left speaker
42 Real right speaker
50 Sound source
60 HRTF-applying sound localization processing unit
70 HRTF storage unit
80 Automobile
100 Acoustic signal processing device
101 Sensor
102 User & user position identification unit
103 User-corresponding HRTF acquisition unit
104 User-corresponding HRTF database
105 HRTF-applying sound localization processing unit
110 User
120 Management server
124 HRTF database
200 Acoustic signal processing device
201 Boarding reservation system
202 Management server
210 HRTF database
251 User
252 Sensor
261 Speaker L
262 Speaker R
263 Communication equipment
271 User
272 User terminal
273 Headphones
301 User
303 Headphones
310 User terminal
311 User-corresponding HRTF database
312 Signal processing unit
313 Communication unit
321 Management server
322 Music delivery server
501 CPU
502 ROM
503 RAM
504 Bus
505 Input/output interface
506 Input unit
507 Output unit
508 Storage unit
509 Communication unit
510 Drive
511 Removal medium

1. An acoustic signal processing device comprising:
a user identification unit that executes a user identification process;
an acquisition unit that acquires a head-related transfer function (HRTF) unique to a user identified by the user identification unit, from among one or a plurality of head-related transfer functions (HRTFs); and
a sound localization processing unit that executes sound localization processing using, as a processing parameter, the head-related transfer function (HRTF) unique to the user acquired by the acquisition unit.

2. The acoustic signal processing device according to claim 1, wherein
the user identification unit additionally
executes a user position identification process, and
the sound localization processing unit
outputs a signal obtained by the sound localization processing from a speaker near a user position identified in the user identification unit.

3. The acoustic signal processing device according to claim 1, wherein
the user identification unit
executes the user identification process with respect to a plurality of users, and
the sound localization processing unit
executes the sound localization processing in parallel using, as a processing parameter, the head-related transfer function (HRTF) of each of the plurality of users identified in the user identification unit.

4. The acoustic signal processing device according to claim 1, wherein
the user identification unit
executes the user identification process based on an image captured by a camera or both the user identification process and a user position identification process.

5. The acoustic signal processing device according to claim 1, wherein
the user identification unit
executes the user identification process based on sensor information or both the user identification process and a user position identification process.

6. The acoustic signal processing device according to claim 1, further comprising
a head-related transfer function (HRTF) database storing the head-related transfer function (HRTF) corresponding to each user.

7. The acoustic signal processing device according to claim 1, wherein
the acquisition unit
accepts user identification information from the user identification unit as input, acquires the head-related transfer function (HRTF) unique to the user from a database internal to the acoustic signal processing device on a basis of the user identification information, and makes an output to the sound localization processing unit.

8. The acoustic signal processing device according to claim 1, wherein
the acquisition unit
accepts user identification information from the user identification unit as input, acquires the head-related transfer function (HRTF) unique to the user from a database in an external server on a basis of the user identification information, and makes an output to the sound localization processing unit.

9. The acoustic signal processing device according to claim 1, wherein
the sound localization processing unit
executes a process of stopping or reducing an output signal to a position where the user identification unit determines that a user is not present.

10. The acoustic signal processing device according to claim 1, wherein
the user identification unit
references registered data in a boarding reservation system to execute the user identification process or both the user identification process and a user position identification process.

11. The acoustic signal processing device according to claim 1, wherein
the user identification unit
executes the user identification process or both the user identification process and a user position identification process, on a basis of a sensor worn by the user or information received from a user terminal.

12. The acoustic signal processing device according to claim 1, wherein
the user identification unit
references preregistered user membership information to execute the user identification process.

13. An acoustic signal processing device comprising:
a storage unit storing a head-related transfer function (HRTF) unique to a user;
an acquisition unit that acquires the head-related transfer function (HRTF) unique to the user from the storage unit; and
a sound localization processing unit that executes sound localization processing using, as a processing parameter, the head-related transfer function (HRTF) unique to the user acquired by the acquisition unit.

14. The acoustic signal processing device according to claim 13, wherein
the sound localization processing unit
executes the sound localization processing on an acoustic signal acquired from an external server.

15. An acoustic signal processing system comprising a user terminal and a server, wherein
the server
transmits an audio signal to the user terminal, and
the user terminal includes
a storage unit storing a head-related transfer function (HRTF) unique to a user,
an acquisition unit that acquires the head-related transfer function (HRTF) unique to the user from the storage unit, and
a sound localization processing unit that executes sound localization processing on the audio signal received from the server using, as a processing parameter, the head-related transfer function (HRTF) unique to the user acquired by the acquisition unit.

16. An acoustic signal processing method executed in an acoustic signal processing device, the method comprising:
executing, by a user identification unit, a user identification process;
acquiring, by an acquisition unit, a head-related transfer function (HRTF) unique to a user identified by the user identification unit, from among one or a plurality of head-related transfer functions (HRTFs); and
executing, by a sound localization processing unit, sound localization processing using, as a processing parameter, the head-related transfer function (HRTF) unique to the user acquired by the acquisition unit.

17. An acoustic signal processing method executed in an acoustic signal processing device,
the acoustic signal processing device including a storage unit storing a head-related transfer function (HRTF) unique to a user, the method comprising:
acquiring, by an acquisition unit, the head-related transfer function (HRTF) unique to the user from the storage unit; and
executing, by a sound localization processing unit, sound localization processing using, as a processing parameter, the head-related transfer function (HRTF) unique to the user acquired by the acquisition unit.

18. A program causing an acoustic signal processing device to execute acoustic signal processing comprising:
causing a user identification unit to execute a user identification process;
causing an acquisition unit to acquire a head-related transfer function (HRTF) unique to a user identified by the user identification unit, from among one or a plurality of head-related transfer functions (HRTFs); and
causing a sound localization processing unit to execute sound localization processing using, as a processing parameter, the head-related transfer function (HRTF) unique to the user acquired by the acquisition unit.
